(19) United States
(12) Patent Application Publication
(10) Pub. No.: US 2006/0282341 A1
(43) Pub. Date: Dec. 14, 2006

(54) On site collection of usage data of potentially hazardous material

(75) Inventors: Tim Dore, Lake Oswego, OR (US); Steve Shubin, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Dolphin Software Inc.

(21) Appl. No.: 11/090,433

(22) Filed: Mar. 25, 2005

(51) Int. Cl. G06Q 10/00

(52) U.S. Cl. 705/28

(57) ABSTRACT

A data collection device is provided with instructions adapted to facilitate on site collection of usage data of potentially hazardous materials at (various locations of) a site of an entity.

### FIELD OF THE INVENTION

The present invention relates generally to the fields of data processing, and potentially hazardous material management.

### BACKGROUND OF THE INVENTION

Numerous modern industries employ potentially hazardous materials in their day-to-day operation, including but are not limited to the development, manufacturing and distribution of their products. Such industries include but are not limited to the semiconductor, electronic, automotive, and refining industries.

The term potentially hazardous material (PHM) as used herein refers to the broad range of materials that may raise health, safety and/or environmental issues, including in particular those, which usage requires maintenance of their material safety data sheets (MSDS). Examples of these materials include but are not limited to the materials regulated by e.g. the Environmental Protection Agency of U.S. Government.

A MSDS specifies the constitutions, special handling, storage, fire fighting procedures of the PHM. Thus, it is important for entities to have an accurate accounting of the PHM used. However, since many entities have far flung distributed operations, it is often difficult to maintain an accurate inventory of the PHM used.

The term “entity” as used herein refers to any organization units, business or non-business, for profit or non-profit.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a data organization suitable for use to implement the PHM Master DB of the server of FIG. 1, in accordance with various embodiments;

FIG. 3 illustrates one aspect of an user interface provided by the PHM Inventory Taking Software of FIG. 1, in accordance with various embodiments; and

FIG. 4 illustrates a flow chart view of selected operations of the PHM Inventory Taking Software of FIG. 1, in accordance with various embodiments.

### DETAILED DESCRIPTION OF ILLUSTRATIVE EMBODIMENTS

Illustrative embodiments of the present invention include but are not limited to a PHM Inventory Taking Device designed for on-site PHM usage data collection, and the method of operation implemented thereon.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

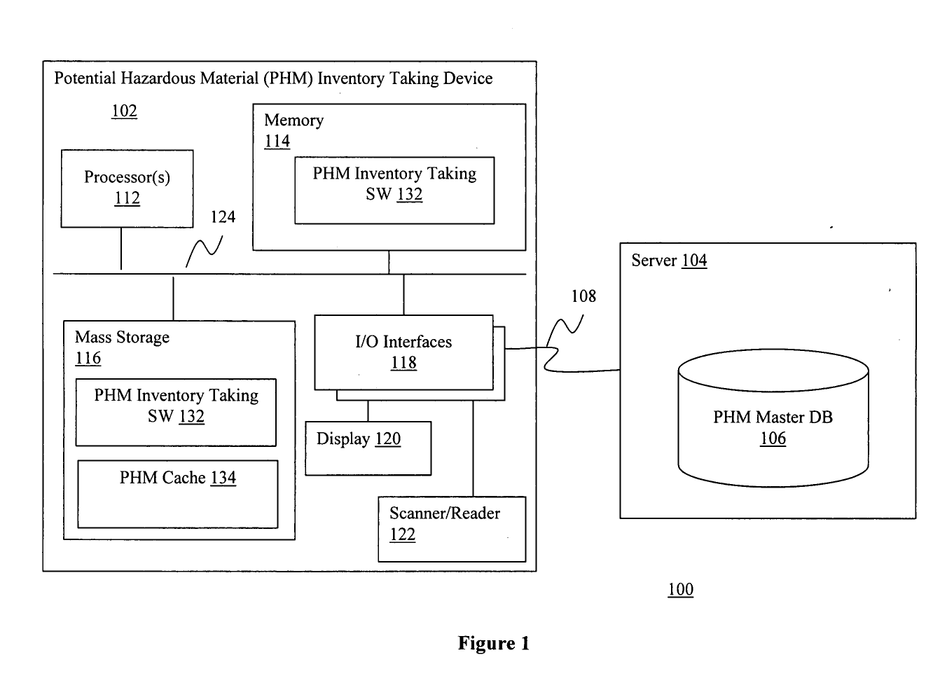

Referring now to FIG. 1, wherein an overview of the present invention, in accordance with various embodiments, is shown. As illustrated, a PHM Inventory Taking Device 102 for inventory taking of PHM usage at the various sites of an entity is provided. As will be described in more detail below, Device 102 is advantageously designed for on-site taking of PHM inventory, and subsequent transfer of the collected information to a server 104 of the entity, e.g. a corporate or central server. Resultantly, PHM usage at the various sites of an entity (including at the various locations of the sites) may be more easily collected, e.g. by a roving compliance officer visiting various locations at the various sites. In turn, the entity is more able to keep track of PHM usage at various sites or locations within the sites.

For the embodiments, Device 102 includes computing processor 112, memory 114 coupled to each other via bus 124. Further, Device 102 includes mass storage device 116, I/O interfaces 118, and a number of I/O devices coupled to each other and the earlier described elements as shown. The I/O devices include in particular, display 120 and scanner/reader 122.

In various embodiments, display 120 may be a flat panel TFT display (TFT=Thin Film Transistor). In other embodiments, display 120 may be a LCD display (LCD=Liquid Crystal Display).

In various embodiments, scanner/reader 122 may be a bar code reader. In other embodiments, scanner/reader 122 may be a RFID reader (RFID=Radio Frequency Identifier).

Scanner/reader 122 may be coupled to I/O interfaces 118 wirelessly or via a wire connection, such as a serial interface connection. An example of a suitable wireless connection includes but is not limited to a Bluetooth connection. Examples of a serial interface connection include but are not limited to a USB connection or an IEEE 1394 connection (USB=Universal Serial Bus, and IEEE=Institute of Electrical and Electronic Engineers). In alternate embodiments, scanner/reader 122 may be coupled to I/O interfaces 118 through a parallel interface.

In various embodiments, I/O interfaces 118 include a communication interface for coupling PHM Inventory Taking Device 102 to server 104, which e.g. may be a central server of an entity. The communication interface may be a wire based or wireless interface, coupling device 102 to server 104 via a wired/wireless local/wire area network. An example of a suitable wired network interface includes but is not limited to an Ethernet interface, and an example of a suitable wireless network interface includes but is not limited to a IEEE 802.11b network interface. In various embodiments, data are transmitted from PHM Inventory Taking Device 102 to server 104 over a private and/or public network, such as the Internet.

Further, in various embodiments, the various elements are embodied in a body (not shown) that is shaped and dimensioned for portable on-site inventory taking. In various embodiments, the body has a thin rectangular box shape, and dimensions that are approximate that of a conventional “letter-sized” writing tablet. In various embodiments, for applications in particularly harsh environments (industrial sites), the body may be formed with strengthened and/or anti-spill materials.

For the embodiments, server 104 includes in particular a PHM Master DB 106 having records of PHM, and their usage at the various sites (or locations of the sites) of the entity. In various embodiments, the records of PHM may be accumulated over time based on PHM usage data collection from the various sites (or locations of the sites) of the entity. In other embodiments, the initial records of PHM may be downloaded from a vendor, e.g. the vendor of PHM Inventory Taking Device 102 or Software 132 (which may be the same or different vendors). The download may be a subset of the PHM data collected by the vendor. The PHM data collected by the vendor may be subset e.g. by industry types.

Except for PHM Inventory Taking Software 132, and the manner these elements are employed, each of these elements represents a broad range of the corresponding element known in the art or to be designed, consistent with the teachings of the present invention. The elements perform their conventional functions, i.e. processing, storage, reading, displaying, and so forth. Accordingly, except for PHM Inventory Taking Software 132, the other elements will not be further described.

In various embodiments, PHM Inventory Device 102 is formed by endowing, i.e. programming a tablet computer, e.g. Compaq Tablet PC TC 1100, available from Hewlett Packard of Palo Alto, Calif., with PHM Inventory Taking Software 132, and coupling that with a bar code scanner, e.g. the LS series handheld scanners available from Symbol Technology of Holtsville, N.Y.

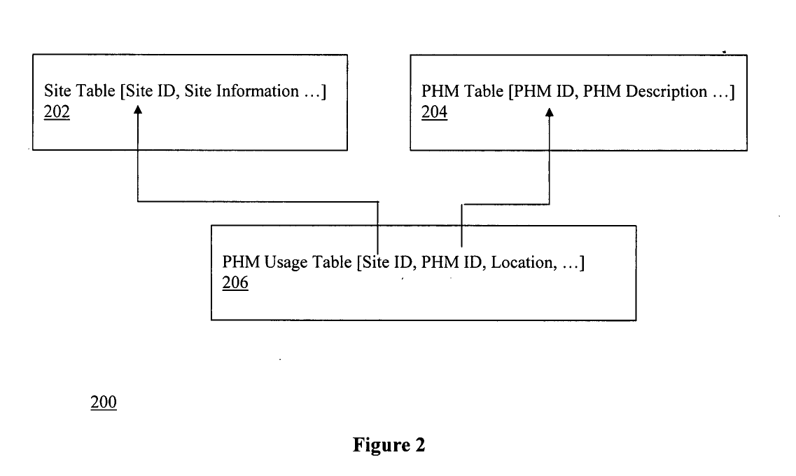

FIG. 2 illustrates a data organization suitable for use to organize data of PMH Master DB 106, in accordance with various embodiments. As illustrated, for the embodiments, data organization 200 includes Site Table 202, PHM Table 204, and PHM Usage Table 206, logically coupled to each other as shown.

Site Table 202 has a number of rows for storing site data of the various sites, one row per site. For the embodiments, each row includes a first column for storing an identification for a site, and one or more additional columns for storing descriptions of the site, including but are not limited to e.g. the state the site is located, an organization unit responsible for the site.

Similarly, PHM Table 204 has a number of rows for storing PHM data, one row per PHM. For the embodiments, each row includes a first column for storing an identification of a PHM, and one or more columns for storing descriptions of the PHM, including but are not limited to e.g. an identifier type for the identifier, a common name of the PHM, a manufacturer of the PHM, synonyms of the PHM, and so forth. In various embodiments, the identifier type of an identifier may be a UPC type (UPC=Uniform Product Code) or a SKU type (SKU=Stock Keeping Unit).

PHM Usage Table 206, on the other hand, has a number of rows for storing PHM usage data, one row per PHM usage. For the embodiments, each row includes a first column for storing an identification of a site using a PHM, and a second column for storing an identification or description of the PHM used. In various embodiments, PHM Usage Table 206 may also include one or more additional columns for storing other data, including but not limited to, container type, unit of measure, current volume on hand, usage rate, site/locations within a site, product category such as window cleaner, solvent, motor oil, and so forth.

Accordingly, site information as well as PHM information may be readily “looked up” from site and PHM tables 202 and 204 respectively, reducing the amount storage required to practice various embodiments of the invention.

In alternate embodiments, PHM Master DB 106 may be practiced with other data organizations instead.

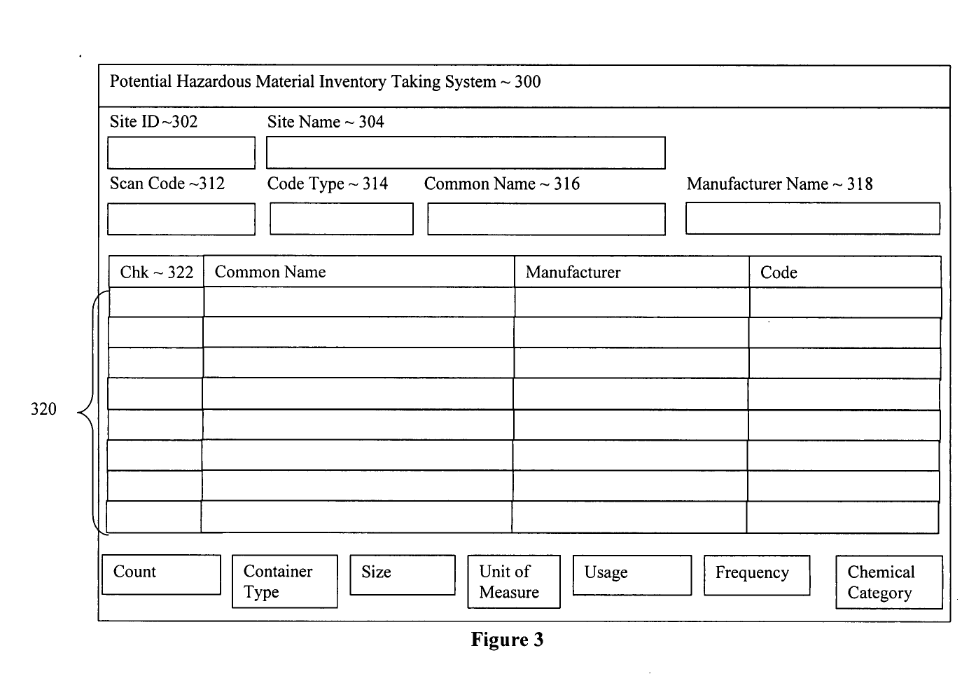

FIG. 3 illustrates a data entry interface 300 of an end user interface provided by PHM Inventory Taking Software 132, in accordance with various embodiments. As illustrated, for the embodiments, data entry interface 300 includes fields 302 and 304 for entering an identification and description of the site, which PHM inventory is being taken, e.g. by a roving compliance officer of an entity.

Additionally, for the embodiments, data entry interface 300 includes fields 312-314 for entering a PHM code and its code type. If available, PHM code may be inputted using scanner/reader 122. In various embodiments, the code types may be included and provided by Software 132 as a drop list for user selection.

For the embodiments, data entry interface 300 also includes fields 316-318 for entering a common name of the PHM and/or a manufacturer name of the PHM. Typically, either or both are entered when the PHM code is not readily available.

For the embodiments, data entry interface 300 further includes a list 320 of the “matching” PHM cached on Device 102, identified by either its code, common name and/or manufacturer, and allowing the listed PHM be checked off 322. For the embodiments, the checking of a PHM denotes the PHM is being used at the site or a specific location of the site, and results in a usage record being created to reflect the usage.

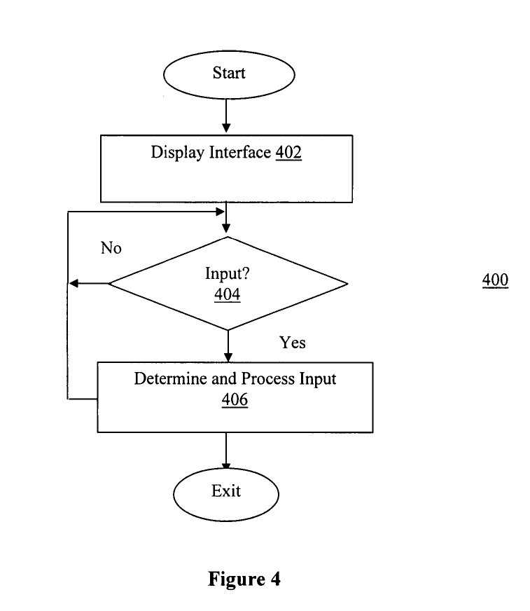

FIG. 4 illustrates a flow chart view 400 of selected operations of PHM Inventory Taking Software 132, in accordance with various embodiments. As illustrated, on start up, Software 132 causes data entry interface 300 to be rendered on display 120, block 402. Thereafter, Software 132 waits for an input, e.g., a site identifier, a site description, a PHM code, a common name, or a manufacturer name, block 404.

On receipt, Software 132 determines the input, and processes the input accordingly, block 406. For examples,
on entry of a site identifier, a site description and so forth, Software 132 stores the information accordingly;
on entry of a PHM code, a common name, or a manufacturer name, Software 132 determines whether the PHM is one of the cached PHM,
if it is, Software 132 causes the cached PHM to be displayed and allows it to be checked to denote usage,
if not, Software 132 facilities the PHM to be added among its cached PHM.

In other embodiments, other processing, in addition to, or in lieu of some of the earlier described processing may be supported.

In various embodiments, the usage records may be sent to server 104 in bulk, e.g., after the roving compliance officer returned to his/her office. In alternate embodiments, the usage records may be sent to server 104 in real time, as each usage record is created.

In various embodiments, PHM cache 134 may be initialized based on a subset of PHM Master DB 106, when PHM Inventory Taking Software 132 is first installed on Device 102. The subset may be the most frequently used PHM of the various sites of an entity, if available, or an arbitrary subset. PHM cache 134 may be refreshed subsequently periodically.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A data collection device comprising:
storage medium having stored therein a plurality of instructions adapted to facilitate on site data collection of potentially hazardous materials used at a site;
one or more processors coupled to the storage medium to execute the instructions; and
a housing to house the storage medium and the one or more processors, the housing having a shape and dimensions selected to enable the device to be portably used for said on site data collection of potentially hazardous materials used at a site.

2. The device of claim 1, wherein the device further comprises a display, and the instructions are adapted to
render on the display an identification or a description of a potentially hazardous material, and
facilitate a user to select the identified or described potentially hazardous material to create a record of usage of the selected potentially hazardous material.

3. The device of claim 1, wherein the storage medium further has stored therein a plurality of identifications or descriptions of potentially hazardous materials, and the instructions are further adapted to retrieve from the storage medium the identification or description of the potentially hazardous material.

4. The device of claim 3, wherein the identification of the potentially hazardous material has a first identifier type.

5. The device of claim 3, wherein the description of the potentially hazardous material includes a common name or a manufacturer of the potentially hazardous material.

6. The device of claim 3, wherein the device further comprises a communication interface coupled to the storage medium and the processor, and the instructions are further adapted to retrieve from a remote source, the identifications or descriptions of the potentially hazardous materials.

7. The device of claim 1, wherein the device further comprises
an input interface coupled to the storage medium and the one or more processors; and
an input device coupled to the input interface to capture and input an identifier of a potentially hazardous material used at the site.

8. The device of claim 7, wherein the input interface is a wireless interface, and the input device is a portable input device wirelessly coupled to the input interface.

9. The device of claim 7, wherein the input interface is a selected one of a serial and a parallel interface.

10. The device of claim 7, wherein the input device is a selected one of a bar code scanner and a RFID reader.

11. A data collection device comprising:
a display;
storage medium having stored therein
a plurality of identifications or descriptions of a plurality of potentially hazardous materials,
a plurality of instructions adapted to facilitate on site data collection of potentially hazardous materials used at a site, including rendering on the display a selected one of the identifications or descriptions of the potentially hazardous materials, and facilitating a user in selecting the displayed identification or description of the selected potentially hazardous material to create a record of usage of the potentially hazardous material at the site; and
one or more processors coupled to the storage medium to execute the instructions.

12. The device of claim 11, wherein the identifier of the potentially hazardous material has a first identifier type.

13. The device of claim 11, wherein the description of the potentially hazardous material includes a common name and a manufacturer of the potentially hazardous material.

14. The device of claim 11, wherein the device further comprises
an input interface coupled to the storage medium and the one or more processors; and
an input device coupled to the input interface to capture and input an identifier of a potentially hazardous material used at the site.

15. The device of claim 14, wherein the input interface is a wireless interface, and the input device is a portable input device wirelessly coupled to the input interface.

16. The device of claim 14, wherein the input interface is a selected one of a serial and a parallel interface.

17. The device of claim 14, wherein the input device is a selected one of a bar code scanner and a RFID reader.

18. A data collection method comprising:
storing a plurality of identifications or descriptions of a plurality of potentially hazardous materials in a portable data collection device;
displaying a selected one of the identifications or descriptions of the potentially hazardous materials on a display of the portable data collection device; and
facilitating selection of the displayed identification or description of the selected potentially hazardous materials, using the portable data collection device, to create a record of usage of the potentially hazardous materials at a site.

19. The method of claim 18, wherein the identification of the selected potentially hazardous material has a first identifier type.

20. The method of claim 18, wherein the description of the selected potentially hazardous material comprises a common name or a manufacturer of the potentially hazardous material.

21. The method of claim 18, wherein the method further comprises capturing and inputting into the portable data collection device, an identifier of a potentially hazardous material used at the site, using an input device.

22. The method of claim 21, wherein the input device is a selected one of a bar code scanner and a RFID reader.
